(19) United States
(12) Patent Application Publication
(10) Pub. No.: US 2017/0311003 A1
(43) Pub. Date: Oct. 26, 2017

(54) METHOD AND APPARATUS FOR PERFORMING ENTROPY ENCODING WITH SIGN DATA REMOVAL AND ASSOCIATED METHOD AND APPARATUS FOR PERFORMING ENTROPY DECODING WITH SIGN DATA RECOVERY

(71) Applicant: MEDIATEK INC., Hsin-Chu (TW)

(72) Inventors: Tung-Hsing Wu, Chiayi City (TW); Li-Heng Chen, Tainan City (TW); Han-Liang Chou, Hsinchu County (TW)

(21) Appl. No.: 15/490,920

(22) Filed: Apr. 19, 2017

Related U.S. Application Data
(60) Provisional application No. 62/324,973, filed on Apr. 20, 2016.

(51) Int. Cl. H04N 19/91; H04N 19/124; H04N 19/182; H04N 19/44

(52) U.S. Cl. CPC H04N 19/91; H04N 19/44; H04N 19/124; H04N 19/182

(57) ABSTRACT

An entropy encoding method includes following steps: receiving symbols of a pixel group; entropy encoding data derived from the symbols of the pixel group to generate a first bitstream portion and a second bitstream portion, wherein the first bitstream portion includes encoded magnitude data of the symbols of the pixel group, and the second bitstream portion includes encoded sign data of at least a portion of the symbols of the pixel group; and generating a bitstream segment of the pixel group by combining at least the first bitstream portion and the second bitstream portion. The pixel group includes a plurality of pixels, and the symbols of the pixel group have a plurality of symbol values of the pixels, respectively. When a first symbol value has a zero magnitude value, a sign value of the first symbol value is not entropy encoded into the second bitstream portion.

### CROSS REFERENCE TO RELATED APPLICATIONS

This application claims the benefit of U.S. provisional application No. 62/324,973, filed on Apr. 20, 2016 and incorporated herein by reference.

### BACKGROUND

The disclosed embodiments of the present invention relate to entropy encoding and entropy decoding, and more particularly, to method and apparatus for performing entropy encoding with sign data removal and associated method and apparatus for performing entropy decoding with sign data recovery.

The conventional video coding standards generally adopt a block based (or coding unit based) coding technique to exploit spatial redundancy. For example, the basic approach is to divide the whole source frame into a plurality of blocks (coding units), and perform prediction on each block (coding unit) to generate residual. In one selected coding mode, the residual may be quantized and then entropy encoded into a bitstream. In another selected coding mode, the residual may be transformed, and the associated transform coefficients may be quantized and then entropy encoded into a bitstream.

If the size of data to be encoded by the entropy encoder can be reduced, the size of the bitstream generated from the entropy encoder can be reduced accordingly. When the bitstream is required to be transmitted from a video encoder to a video decoder via a transmission means, the bandwidth requirement of the transmission means can be mitigated, and the power consumption of the transmission means can also be reduced.

### SUMMARY

In accordance with exemplary embodiments of the present invention, method and apparatus for performing entropy encoding with sign data removal and associated method and apparatus for performing entropy decoding with sign data recovery are disclosed.

According to a first aspect of the present invention, an exemplary entropy encoding method is disclosed. The exemplary entropy encoding method includes: receiving symbols of a pixel group; entropy encoding data derived from the symbols of the pixel group to generate a first bitstream portion and a second bitstream portion, wherein the first bitstream portion comprises encoded magnitude data of the symbols of the pixel group, and the second bitstream portion comprises encoded sign data of at least a portion of the symbols of the pixel group; and generating a bitstream segment of the pixel group by combining at least the first bitstream portion and the second bitstream portion. The pixel group comprises a plurality of pixels, and the symbols of the pixel group have a plurality of symbol values of the pixels, respectively. When a first symbol value has a zero magnitude value, a sign value of the first symbol value is not entropy encoded into the second bitstream portion.

According to a second aspect of the present invention, an exemplary entropy decoding method is disclosed. The exemplary entropy decoding method includes: receiving a bitstream segment composed of a first bitstream portion and a second bitstream portion; entropy decoding the bitstream segment to derive decoded magnitude data of symbols of a pixel group from the first bitstream portion and derive decoded sign data of at least a portion of the symbols of the pixel group from the second bitstream portion, wherein the pixel group comprises a plurality of pixels, the symbols of the pixel group have a plurality of symbol values of the pixels, respectively; and generating decoded data of the symbols of the pixel group according to the decoded magnitude data of the symbols and the decoded sign data of said at least a portion of the symbols, wherein when a decoded magnitude value of a first symbol value is a zero magnitude value, the decoded sign data contain no sign value of the first symbol value, and the sign value of the first symbol value is recovered by directly using a pre-defined sign value.

According to a third aspect of the present invention, an exemplary entropy encoder is disclosed. The exemplary entropy encoder includes an entropy encoding circuit and a combining circuit. The entropy encoding circuit is arranged to receive symbols of a pixel group, and entropy encode data derived from the symbols of the pixel group to generate a first bitstream portion and a second bitstream portion, wherein the first bitstream portion comprises encoded magnitude data of the symbols of the pixel group, and the second bitstream portion comprises encoded sign data of at least a portion of the symbols of the pixel group. The combining circuit is arranged to generate a bitstream segment of the pixel group by combining at least the first bitstream portion and the second bitstream portion. The pixel group comprises a plurality of pixels, and the symbols of the pixel group have a plurality of symbol values of the pixels, respectively. When a first symbol value has a zero magnitude value, the entropy encoding circuit does not entropy encode a sign value of the first symbol value into the second bitstream portion.

According to a fourth aspect of the present invention, an exemplary entropy decoder is disclosed. The exemplary entropy decoder includes an entropy decoding circuit and a recovery circuit. The entropy decoding circuit is arranged to receive a bitstream segment composed of a first bitstream portion and a second bitstream portion, and entropy decode the bitstream segment to derive decoded magnitude data of symbols of a pixel group from the first bitstream portion and derive decoded sign data of at least a portion of the symbols of the pixel group from the second bitstream portion. The recovery circuit is arranged to generate decoded data of the symbols of the pixel group according to the decoded magnitude data of the symbols and the decoded sign data of said at least a portion of the symbols. The pixel group comprises a plurality of pixels, and the symbols of the pixel group have a plurality of symbol values of the pixels, respectively. When a decoded magnitude value of a first symbol value is a zero magnitude value, the decoded sign data contain no sign value of the first symbol value, and the recovery circuit recovers the sign value of the first symbol value by directly using a pre-defined sign value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary entropy encoder according to an embodiment of the present invention.

FIG. 2 is a diagram illustrating a bitstream segment generated from concatenating different bitstream portions according to an embodiment of the present invention.

FIG. 3 is a diagram illustrating a bitstream segment generated from interleaving parts of different bitstream portions according to an embodiment of the present invention.

FIG. 4 is a block diagram illustrating an exemplary entropy decoder according to an embodiment of the present invention.

FIG. 5 is a diagram illustrating a parallel decoding design of different bitstream portions in a bitstream segment according to an embodiment of the present invention.

FIG. 6 is a diagram illustrating a non-parallel decoding design of different bitstream portions in a bitstream segment according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The present invention proposes applying entropy encoding to magnitude data of symbols (e.g., absolute values of prediction residual, absolute values of quantized prediction residual, or absolute values of quantized transform coefficients) and sign data of the symbols separately to thereby generate a first bitstream portion and a second bitstream portion that are combined to form a final bitstream segment, wherein the first bitstream portion contains encoded magnitude data of the symbols and the second bitstream portion contains encoded sign data of at least a portion (i.e., part or all) of the symbols. In the following specification description, the term “symbol” may mean any data to be entropy encoded by an entropy encoder. For example, a symbol is associated with or corresponds to the residual, such as a quantized prediction residual under an advanced display stream compression (A-DSC) block prediction mode or a quantized transform coefficient under an A-DSC transform mode. For another example, a symbol may be a quantized transform coefficient under an A-DSC transfer mode. Since the magnitude data and the sign data are entropy encoded separately, a proposed sign data removal technique can be employed by the entropy encoder to shorten the final bitstream segment by reducing the size of the second bitstream portion. For example, when a symbol value has zero magnitude, the magnitude data of the symbol value is encoded to be part of the first bitstream portion, while the sign data of the symbol value is not presented in the second bitstream portion. An entropy decoder of a decoding apparatus is configured to perform an inverse of the entropy encoding operation performed by an entropy encoder of an encoding apparatus. Hence, a proposed sign data recovery technique can be employed by the entropy decoder to recover the sign data not transmitted by the final bitstream segment due to sign data removal. Further details of the proposed sign data removal technique and sign data recovery technique are described with reference to the accompanying drawings.

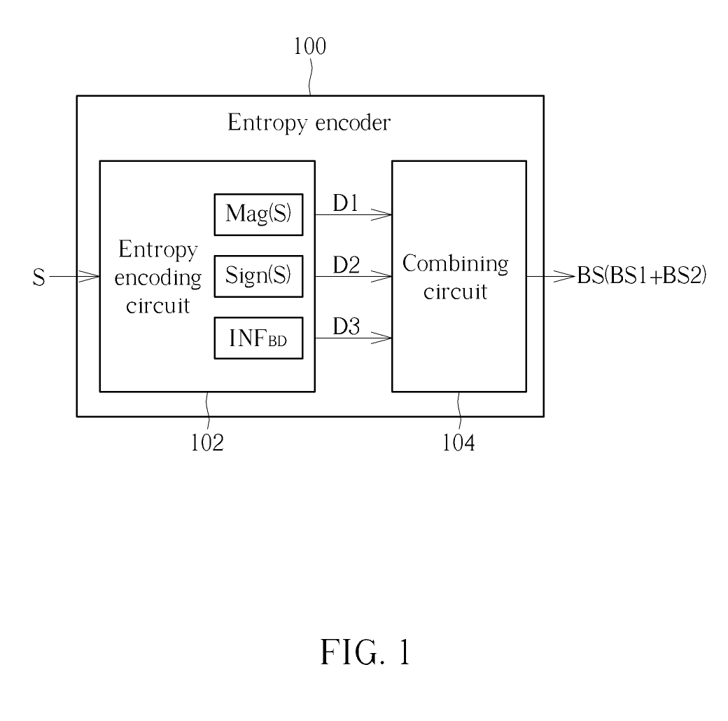

FIG. 1 is a block diagram illustrating an exemplary entropy encoder according to an embodiment of the present invention. By way of example, but not limitation, the entropy encoder 100 may be employed by an advanced display stream compression (A-DSC) encoder. In this embodiment, the entropy encoder 100 supports the proposed sign data removal functionality. As shown in FIG. 1, the entropy encoder 100 includes an entropy encoding circuit 102 and a combining circuit 104. The entropy encoding circuit 102 is a core part of the entropy encoder 100. The entropy encoding circuit 102 is arranged to receive symbols S of a pixel group (e.g., prediction residual, quantized prediction residue or quantized transform coefficients of a 2×2 pixel group), and entropy encode data derived from the symbols S of the pixel group to generate a first bitstream portion BS1 and a second bitstream portion BS2. In this embodiment, the first bitstream portion BS1 includes encoded magnitude data D1 of the symbols S of the pixel group, and the second bitstream portion BS2 includes encoded sign data D2 of at least a portion (i.e., part or all) of the symbols S of the pixel group. In addition, bit-length information INF_{BD} associated with entropy encoding of magnitude data Mag(S) of the symbols S of the pixel group may also be entropy encoded to generate the encoded bit-length data D3. Hence, the bit-length information INF_{BD} can be signaled to a decoding apparatus through the transmitted bitstream segment BS.

In this embodiment, entropy encoding of the magnitude data Mag(S) and entropy encoding of the sign data Sign(S) can be performed separately. The magnitude data Mag(S) include magnitude values (i.e., absolute values) of symbol values of all symbols S of the pixel group, and are entropy encoded to generate the encoded magnitude data D1. When a symbol value has a zero magnitude value, a sign value of the symbol value is not entropy encoded into the second bitstream portion BS2. In other words, when sign data removal is enabled due to at least one symbol value of the symbols S of the pixel group has a zero magnitude value, the sign data Sign(S) to be entropy encoded do not include the sign value of the at least one symbol value with zero magnitude. On the other hand, when sign data removal is not enabled due to none of the symbol values of the symbols S of the pixel group has a zero magnitude value, the sign data Sign(S) to be entropy encoded include sign values of all symbol values of the symbols S of the pixel group.

In a first exemplary magnitude data encoding design, the entropy encoding circuit 102 may entropy encode the magnitude data Mag(S) (i.e., magnitude values of symbol values of all symbols S of the pixel group) by fixed length coding. For example, the entropy encoding circuit 102 determines a bit-length value by a maximum of minimum bit-lengths needed to fully represent the magnitude values of the symbol values of all symbols S of the pixel group in binary notation, and entropy encodes each of the magnitude values of the symbol values according to the bit-length value, where a bit-length of an encoded magnitude value of each of the symbol values is equal to the same bit-length value. For better understanding of technical features of the present invention, several entropy encoding examples are provided as below.

Consider a first example where a pixel group includes 5 pixels and symbols of the pixel group include 5 symbol values {−11, 3, 0, 5, −20}. Hence, the magnitude data (i.e., absolute values) of the symbol values {−11, 3, 0, 5, −20} are {11, 3, 0, 5, 20}, and the sign data (i.e., sign values) of the symbol values {−11, 3, 0, 5, −20} are {−, +, +, +, −}. The maximum of minimum bit-lengths needed for fully representing the absolute values {11, 3, 0, 5, 20} in binary notation is 5. That is, the largest absolute value {20} fully represented in binary notation needs at least 5 bits. Hence, each of the absolute values {11, 3, 0, 5, 20} is entropy encoded with the maximum bit-length {5}, such that the size of encoded magnitude data of each symbol value is equal to the same maximum bit-length {5}. For example, the entropy encoding result of the magnitude data {11, 3, 0, 5, 20} may be {01011, 00011, 00000, 00101, 10100}. Hence, the first bitstream portion BS1 includes a bit sequence “01011 00011 00000 00101 10100”. It should be noted that the bit-length information INF_{BD} is set by the maximum bit-length {INF_{BD}=5}, and may be encoded and signaled in the bitstream segment BS. For example, the first bitstream portion BS1 may include the encoded bit-length data D3 preceding the encoded magnitude data D1 of the symbols S.

The entropy encoding of the sign data {−, +, +, +, −} uses one bit for representing the sign data of one symbol value, and uses sign data removal to remove sign data of any symbol value with zero magnitude. For example, the positive sign {+} may be represented by one bit “0”, and the negative sign {−} may be represented by the other bit “1”. Since the third symbol value {0} has zero magnitude, the sign value {+} of the third symbol value {0} is not encoded into the second bitstream portion BS2. Hence, the second bitstream portion BS2 includes a bit sequence “1 0 0 1”.

Consider a second example where a pixel group includes 3 pixels and symbols (e.g., luminance quantized residuals) of the pixel group include 3 symbol values {0, −30, 1} to be encoded in Display Stream Compression (DSC) standard. Hence, the magnitude data (i.e., absolute values) of the symbol values {0, −30, 1} are {0, 30, 1}, and the sign data (i.e., sign values) of the symbol values {0, −30, 1} are {+, −, +}. The maximum of minimum bit-lengths needed for fully representing the absolute values {0, 30, 1} in binary notation is 5. That is, the largest absolute value {30} fully represented in binary notation needs at least 5 bits. Hence, each of the absolute values {0, 30, 1} is entropy encoded with the maximum bit-length {5}, such that the size of encoded magnitude data of each symbol value is equal to the same maximum bit-length {5}. For example, the entropy encoding result of the magnitude data {0, 30, 1} may be {00000, 11110, 00001}. Hence, the first bitstream portion BS1 includes a bit sequence “00000 11110 00001”. It should be noted that the bit-length information INF_{BD} is set by the maximum bit-length {INF_{BD}=5}, and may be encoded and signaled in the bitstream segment BS. For example, the first bitstream portion BS1 may include the encoded bit-length data D3 preceding the encoded magnitude data D1 of the symbols S.

The entropy encoding of the sign data {+, −, +} uses one bit for representing the sign data of one symbol value, and uses sign data removal to remove sign data of any symbol value with zero magnitude. For example, the positive sign {+} may be represented by one bit “0”, and the negative sign {−} may be represented by the other bit “1”. Since the first symbol value {0} has zero magnitude, the sign value {+} of the first symbol value {0} is not encoded into the second bitstream portion BS2. Hence, the second bitstream portion BS2 includes a bit sequence “1 0”.

Consider a third example where a pixel group includes 4 pixels and symbols (e.g., luminance quantized residuals) of the pixel group include 4 symbol values {0, 0, 0, −3} to be encoded in Advanced Display Stream Compression (A-DSC) standard. Hence, the magnitude data (i.e., absolute values) of the symbol values {0, 0, 0, −3} are {0, 0, 0, 3}, and the sign data (i.e., sign values) of the symbol values {0, 0, 0, −3} are {+, +, +, −}. The maximum of minimum bit-lengths needed for fully representing the absolute values {0, 0, 0, 3} in binary notation is 2. That is, the largest absolute value {3} fully represented in binary notation needs at least 2 bits. Hence, each of the absolute values {0, 0, 0, 3} is entropy encoded with the maximum bit-length {2}, such that the size of encoded magnitude data of each symbol value is equal to the same maximum bit-length {2}. For example, the entropy encoding result of the magnitude data {0, 0, 0, 3} may be {00, 00, 00, 11}. Hence, the first bitstream portion BS1 includes a bit sequence “00 00 00 11”. It should be noted that the bit-length information INF_{BD} is set by the maximum bit-length {INF_{BD}=2}, and may be encoded and signaled in the bitstream segment BS. For example, the first bitstream portion BS1 may include the encoded bit-length data D3 preceding the encoded magnitude data D1 of the symbols S.

The entropy encoding of the sign data {+, +, +, −} uses one bit for representing the sign data of one symbol value, and uses sign data removal to remove sign data of any symbol value with zero magnitude. For example, the positive sign {+} may be represented by one bit “0”, and the negative sign {−} may be represented by the other bit “1”. Since the first symbol value {0}, the second symbol value {0} and the third symbol value {0} have zero magnitude, the sign value {+} of the first symbol value {0}, the sign value {+} of the second symbol value {0} and the sign value {+} of the third symbol value {0} are not encoded into the second bitstream portion BS2. Hence, the second bitstream portion BS2 includes one bit “1”.

In a second exemplary magnitude data encoding design, the entropy encoding circuit 102 may entropy encode the magnitude data Mag(S) (i.e., magnitude values of all symbol values of the symbols S of the pixel group) by variable length coding. For example, the variable length coding may be Golomb-Rice (GR) coding. Hence, an encoded magnitude value of each of the symbol values includes a prefix part and a suffix part according to the GR coding.

Consider a fourth example where a pixel group includes 4 pixels and symbols of the pixel group include 4 symbol values {−3, 0, 5, −2} to be encoded. Hence, the magnitude data (i.e., absolute values) of the symbol values {−3, 0, 5, −2} are {3, 0, 5, 2}, and the sign data (i.e., sign values) of the symbol values {−3, 0, 5, −2} are {−, +, +, −}. The GR coding is applied to the magnitude data {3, 0, 5, 2}. In this case, the bit-length of the suffix part is set by 2. In other words, the suffix parts of all GR codes generated for the magnitude data {3, 0, 5, 2} have the same bit-length {2}. The prefix part of the GR code of the magnitude value {3} is {0}, and the suffix part of the GR code of the magnitude value {3} is {11}. The prefix part of the GR code of the magnitude value {0} is {0}, and the suffix part of the GR code of the magnitude value {0} is {00}. The prefix part of the GR code of the magnitude value {5} is {10}, and the suffix part of the GR code of the magnitude value {5} is {01}. The prefix part of the GR code of the magnitude value {2} is {0}, and the suffix part of the GR code of the magnitude value {2} is {10}. Hence, the entropy encoding result of the magnitude data {3, 0, 5, 2} is {0 11 0 0010 01010}. The first bitstream portion BS1 includes a bit sequence “0110001001010”. It should be noted that the bit-length information INF_{BD} is set by the suffix-part bit-length {INF_{BD}=2}, and may be encoded and signaled in the final bitstream segment BS. For example, the first bitstream portion BS1 may include the encoded bit-length data D3 preceding the encoded magnitude data D1 of the symbols S.

The entropy encoding of the sign data {−, +, +, −} uses one bit for representing the sign data of one symbol value, and uses sign data removal to remove sign data of any symbol value with zero magnitude. For example, the positive sign {+} may be represented by one bit “1”, and the negative sign {−} may be represented by the other bit “0”. Since the second symbol value {0} has zero magnitude, the sign value {+} of the second symbol value {0} is not encoded into the second bitstream portion BS2. Hence, the second bitstream portion BS2 includes a bit sequence “0 1 0”.

In above examples, the entropy encoding of the sign data uses one bit for representing the sign data of one non-zero symbol value after sign data removal is performed to remove sign data of any symbol value with zero magnitude. Alternatively, the second bitstream portion BS2 may be generated by run-length coding. That is, run-length coding is applied to sign data of a least a portion (i.e., part or all) of symbol values after sign data removal is performed to remove sign data of any symbol value with zero magnitude.

Consider a fifth example where a pixel group includes 4 pixels and symbols of the pixel group include 4 symbol values {1, 1, 0, −3} to be encoded. Hence, the magnitude data (i.e., absolute values) of the symbol values {1, 1, 0, −3} are {1, 1, 0, 3}, and the sign data (i.e., sign values) of the symbol values {1, 1, 0, −3} are {+, +, +, −}. The magnitude data {1, 1, 0, 3} may be entropy encoded using the aforementioned fixed length coding or the aforementioned variable length coding (e.g., GR coding). Supposing that the absolute values {1, 1, 0, 3} are entropy encoded using the aforementioned fixed length coding, the maximum of minimum bit-lengths needed for fully representing the absolute values {1, 1, 0, 3} in binary notation is 2. That is, the largest absolute value {3} fully represented in binary notation needs at least 2 bits. Hence, each of the absolute values {1, 1, 0, 3} is entropy encoded with the maximum bit-length {2}, such that the size of encoded magnitude data of each symbol value is equal to the same maximum bit-length {2}. For example, the entropy encoding result of the magnitude data {1, 1, 0, 3} may be {01, 01, 00, 11}. Hence, the first bitstream portion BS1 includes a bit sequence “01 01 00 11”. It should be noted that the bit-length information INF_{BD} is set by the maximum bit-length {INF_{BD}=2}, and may be encoded and signaled in the bitstream segment BS. For example, the first bitstream portion BS1 may include the encoded bit-length data D3 preceding the encoded magnitude data D1 of the symbols S.

The entropy encoding of the sign data {+, +, +, −} uses one bit for representing the sign data of one symbol value, uses sign data removal to remove sign data of any symbol value with zero magnitude, and applies run-length coding to the sign data of a least a portion (i.e., part or all) of symbol values after sign data removal is performed to remove sign data of any symbol value with zero magnitude. For example, the positive sign {+} may be represented by one bit “0”, and the negative sign {−} may be represented by the other bit “1”. Since the third symbol value {0} has zero magnitude, the sign value {+} of the third symbol value {0} is removed from the sign data to be entropy encoded by using the run-length coding. In other words, the sign value {+} of the third symbol value {0} is not encoded into the second bitstream portion BS2. After the sign data removal is done, the sign values to be entropy encoded by run-length coding are {0, 0, 1}. There are two 0's followed by one 1. The run-length coding may be implemented using any feasible run-length coding algorithm. For example, it is assumed that 3 bits are used for each run representation, there are only two run types (“0” bit and “1” bit), the first run type is always “0”, and the current run type is different from the previous run type. Hence, two 0's of the sign values {0, 0, 1} are represented by the run representation {010} according to run-length coding, and one 1 of the sign values {0, 0, 1} is represented by the run representation {001} according to run-length coding. The second bitstream portion BS2 includes a bit sequence “010001”.

After the first bitstream portion BS1 and the second bitstream portion BS2 are generated from the entropy encoding circuit 102, the combining circuit 104 is arranged to generate the bitstream segment BS of the pixel group by combining at least the first bitstream portion BS1 and the second bitstream portion BS2. In a first exemplary bitstream segment generation design, the combining circuit 104 generates the bitstream segment BS of the pixel group by concatenating the first bitstream portion BS1 and the second bitstream portion BS2, where an end of the first bitstream portion BS1 may be immediately followed by a start of the second bitstream portion BS2.

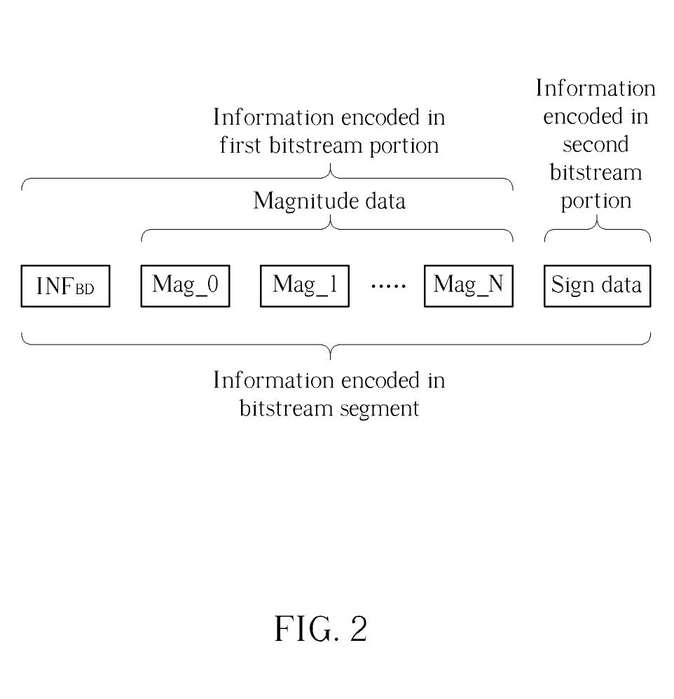

FIG. 2 is a diagram illustrating a bitstream segment generated from concatenating different bitstream portions according to an embodiment of the present invention. In this embodiment, the magnitude data of the pixel group include magnitude values (absolute values) Mag_0, Mag_1, . . . Mag_N. The bit-length information INF_{BD} associated with entropy encoding of the magnitude values Mag_0-Mag_N and the magnitude values Mag_0-Mag_N are entropy encoded to form the first bitstream portion BS1. The sign data only include sign value(s) of non-zero symbol value(s) due to the proposed sign data removal, and are entropy encoded into the second bitstream portion BS2. In this embodiment, the first bitstream portion BS1 and the second bitstream portion BS2 are concatenated to form the bitstream segment BS.

In a second exemplary bitstream segment generation design, the combining circuit 104 generates the bitstream segment BS of the pixel group by interleaving parts of the first bitstream portion BS1 and parts of the second bitstream portion BS2, where an encoded magnitude value and an encoded sign value of a non-zero symbol value are concatenated in the bitstream segment BS.

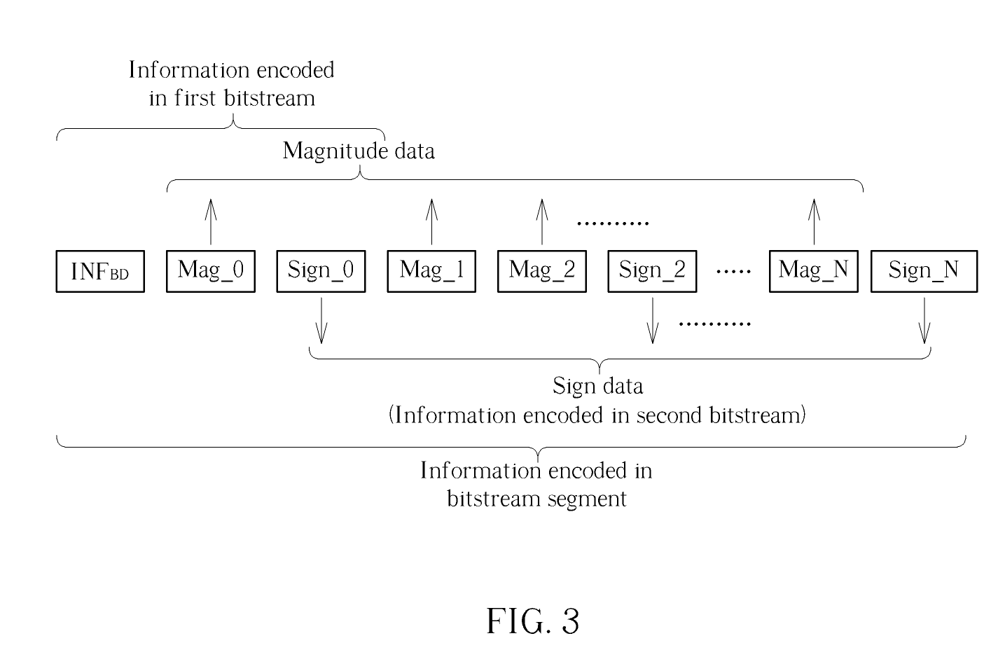

FIG. 3 is a diagram illustrating a bitstream segment generated from interleaving parts of different bitstream portions according to an embodiment of the present invention. In this embodiment, the magnitude data of the pixel group include magnitude values (absolute values) Mag_0, Mag_1, Mag_2, . . . Mag_N. The bit-length information INF_{BD} associated with entropy encoding of the magnitude values Mag_0-Mag_N and the magnitude values Mag_0-Mag_N are entropy encoded to form the first bitstream portion BS1. The sign data only include sign values Sign_0, Sign_2, . . . Sign_N of non-zero symbol values due to the proposed sign data removal, and are entropy encoded into the second bitstream portion BS2. In this embodiment, parts of the first bitstream portion BS1 and parts of the second bitstream portion BS2 are interleaved to form the bitstream segment BS. For a non-zero symbol value, a corresponding encoded magnitude value (e.g., Mag_0/Mag_2/Mag_N) in the bitstream segment BS is followed by a corresponding encoded sign value (e.g., Sign_0/Sign_2/Sign_N) in the bitstream segment BS. For a zero symbol value, only the corresponding encoded magnitude value (e.g., Mag_1) is presented in the bitstream segment BS. Hence, the corresponding encoded magnitude value (e.g., Mag_1) of the zero symbol value and the corresponding encoded sign value (e.g., Sign_0) of the preceding non-zero symbol value are concatenated, and the corresponding encoded magnitude value (e.g., Mag_1) of the zero symbol value and the corresponding encoded magnitude value (e.g., Mag_2) of the following non-zero symbol value are concatenated.

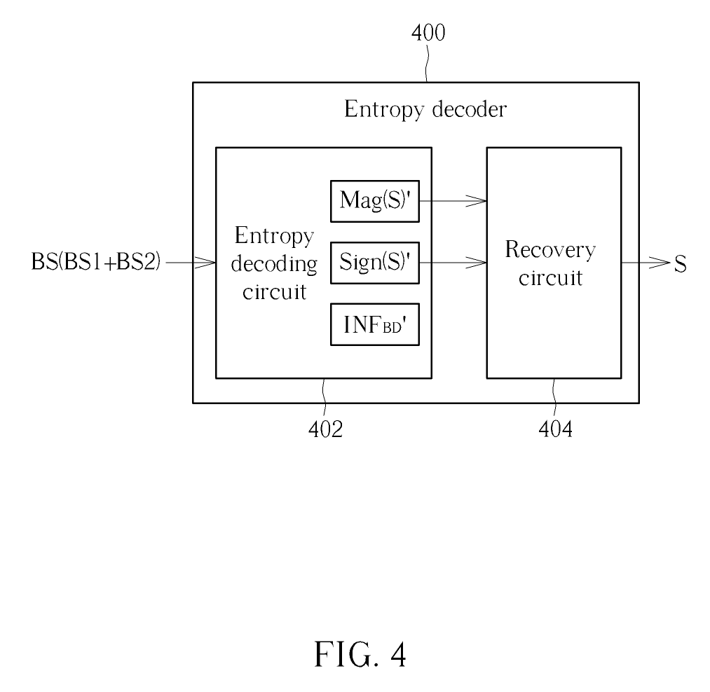

The bitstream segment BS of the pixel group is generated from the entropy encoder 100 of an encoding apparatus, and may be delivered to a decoding apparatus via a transmission means. An entropy decoder of the decoding apparatus may be configured to entropy decode the bitstream segment BS of the pixel group to obtain decoded magnitude data and decoded sign data of symbols of the pixel group. FIG. 4 is a block diagram illustrating an exemplary entropy decoder according to an embodiment of the present invention. By way of example, but not limitation, the entropy decoder 400 may be employed by an advanced display stream compression (A-DSC) decoder. In this embodiment, the entropy decoder 400 supports the proposed sign data recovery functionality, and is used to entropy decode the bitstream segment BS (which is composed of first bitstream portion BS1 and second bitstream portion BS2) generated from the entropy encoder 100 shown in FIG. 1. As shown in FIG. 4, the entropy decoder 400 includes an entropy decoding circuit 402 and a recovery circuit 404. The entropy decoding circuit 402 is arranged to receive the bitstream segment BS composed of the first bitstream portion BS1 (which includes encoded bit-length information D3 and encoded magnitude data D1) and the second bitstream portion BS2 (which includes the encoded sign data D2), and entropy decode the bitstream segment BS to obtain decoded data of symbols S of a pixel group (e.g., a 2×2 pixel group). Specifically, the first bitstream portion BS1 contains encoded magnitude data of the symbols S of the pixel group, and the second bitstream portion BS2 contains encoded sign data of at least a portion (i.e., part or all) of the symbols S of the pixel group.

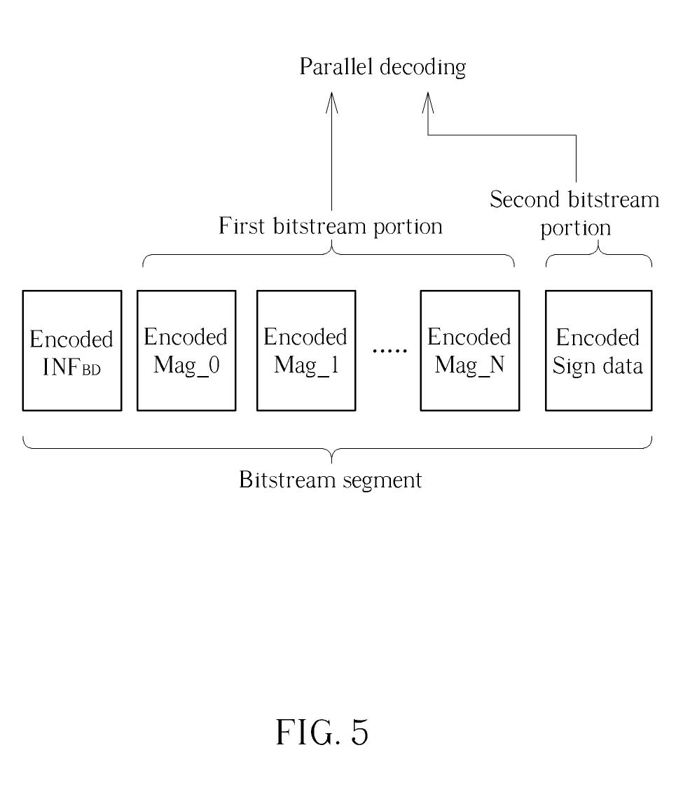

When the first bitstream portion BS1 and the second bitstream portion BS2 are concatenated in the bitstream segment BS, the entropy decoding circuit 402 may be configured to have two entropy decoding units for entropy decoding the first bitstream portion BS1 and the second bitstream portion BS2 in a parallel manner. FIG. 5 is a diagram illustrating a parallel decoding design of different bitstream portions in a bitstream segment according to an embodiment of the present invention. One entropy decoding unit of the entropy decoding circuit 402 entropy decodes the first bitstream portion BS1 to obtain decoded bit-length information INF_{BD}′ and decoded magnitude data Mag(S)′, and another entropy decoding unit of the entropy decoding circuit 402 entropy decodes the second bitstream portion BS2 to obtain decoded sign data Sign(S)′. As shown in FIG. 5, the first bitstream portion BS1 includes the encoded bit-length information INF_{BD} and the encoded magnitude values Mag_0-Mag_N. Hence, the entropy decoding circuit 402 may entropy decode the encoded bit-length information INF_{BD} and the encoded magnitude values Mag_0-Mag_N one by one. The decoded bit-length information INF_{BD}′ includes a bit-length value associated with entropy decoding of the encoded magnitude values Mag_0-Mag_N.

For example, each of the encoded magnitude values Mag_0-Mag_N is generated by fixed length coding. Hence, the entropy decoding circuit 402 entropy decodes the encoded magnitude values Mag_0-Mag_N according to a bit-length value indicated by the decoded bit-length information INF_{BD}′, where a bit-length of each the encoded magnitude values Mag_0-Mag_N is equal to the bit-length value.

For another example, each of the encoded magnitude values Mag_0-Mag_N is generated by variable length coding (e.g., GR coding). Hence, each of the encoded magnitude values Mag_0-Mag_N includes a prefix part and a suffix part according to the GR coding. The entropy decoding circuit 402 performs GR decoding upon the encoded magnitude values Mag_0-Mag_N according to a bit-length value (e.g., a bit-length of a suffix part of each GR code) indicated by the decoded bit-length information INF_{BD}′.

In addition, the entropy decoding circuit 402 may start entropy decoding of the first bitstream portion BS1 and entropy decoding of the second bitstream portion BS2 at the same time. Hence, the entropy decoding circuit 402 further obtains decoded sign data Sign(S)′ by entropy decoding the second bitstream portion BS2 through another entropy decoding unit. For example, each sign value is entropy encoded using a single bit, where a positive sign {+} may be represented by one bit “0”, and a negative sign {−} may be represented by the other bit “1”. Hence, each bit included in the second bitstream portion BS2 is indicative of one sign value. For another example, sign values are entropy encoded using run-length coding. Hence, the entropy decoding circuit 402 entropy decodes the second bitstream portion BS2 by run-length decoding, such that each run representation presented in the second bitstream portion BS2 is decoded into one or more same sign values (e.g., 0's or l's).

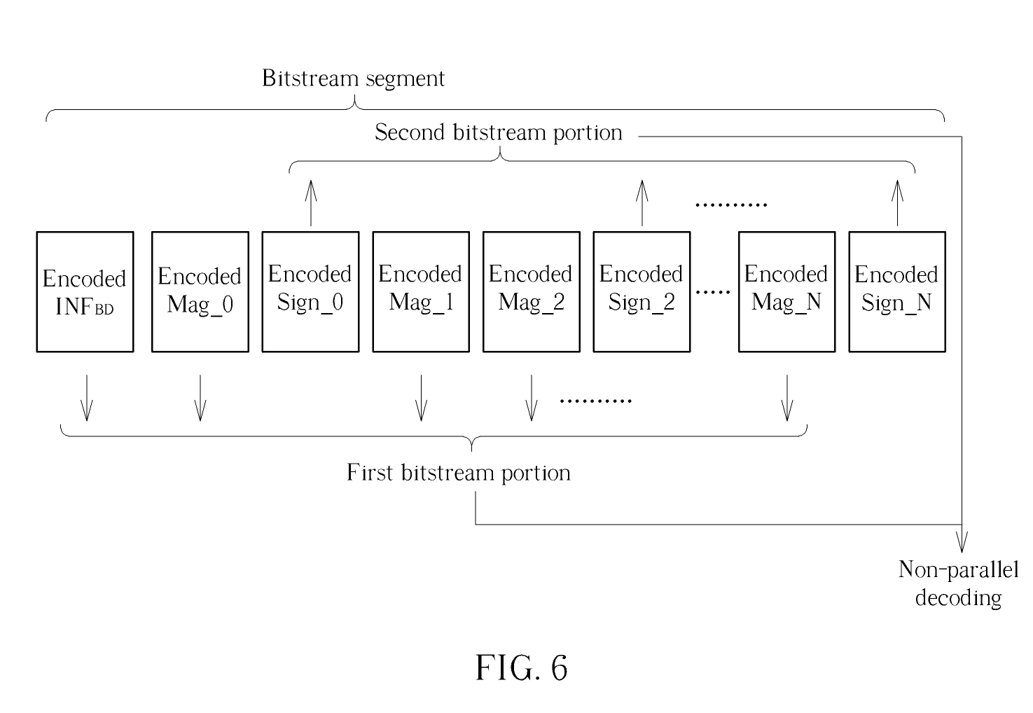

Alternatively, when parts of the first bitstream portion BS1 and parts of the second bitstream portion BS2 are interleaved in the bitstream segment BS, the entropy decoding circuit 402 may be configured to have one entropy decoding unit for entropy decoding the first bitstream portion BS1 and the second bitstream portion BS2 in a non-parallel manner. FIG. 6 is a diagram illustrating a non-parallel decoding design of different bitstream portions in a bitstream segment according to an embodiment of the present invention. The entropy decoding circuit 402 entropy decodes the first bitstream portion BS1 to obtain decoded bit-length information INF_{BD}′ and decoded magnitude data Mag(S)′, and further entropy decodes the second bitstream portion BS2 to obtain decoded sign data Sign(S)′. As shown in FIG. 6, the first bitstream portion BS1 includes the encoded bit-length information INF_{BD} and the encoded magnitude values Mag_0, Mag_1, Mag_2, . . . Mag_N, and the second bitstream portion BS2 includes the encoded sign values Sign_0, Sign_2, . . . Sign(N). For a symbol with non-zero magnitude, an encoded magnitude value (e.g., Mag_0/Mag_2/Mag_N) and an encoded sign value (e.g., Sign_0/Sign_2/Sign_N) are concatenated in the bitstream segment BS. For a symbol with zero magnitude, only an encoded magnitude value (e.g., Mag_1) is presented in the bitstream segment BS. Since the encoded magnitude values Mag_0, Mag_1, Mag_2, . . . Mag_N and the encoded sign values Sign_0, Sign_2, . . . Sign (N) are interleaved in the bitstream segment BS, the interleaved encoded magnitude values and encoded sign values are entropy decoded in a sequential manner. For example, the entropy decoding circuit 402 entropy decodes an encoded magnitude value and an encoded sign value of a symbol value in a sequential manner, where a decoded magnitude value of the symbol value has a non-zero magnitude value. For another example, the entropy decoding circuit 402 entropy decodes an encoded magnitude value of a current symbol value and an encoded magnitude value of a following symbol value in a sequential manner, where a decoded magnitude value of the current symbol value has a zero magnitude value. For yet another example, the entropy decoding circuit 402 entropy decodes an encoded sign value of a preceding symbol value and an encoded magnitude value of a current symbol value in a sequential manner, where a decoded magnitude value of the current symbol value has a zero magnitude value.

As mentioned above, each of the encoded magnitude values Mag_0-Mag_N may be generated by fixed length coding or variable length coding (e.g., GR coding). Hence, the entropy decoding circuit 402 entropy decodes the encoded magnitude values Mag_0-Mag_N according to a bit-length value indicated by the decoded bit-length information INF_{BD}′. If each of the encoded magnitude values Mag_0-Mag_N is generated by fixed length coding, a bit-length of each the encoded magnitude values Mag_0-Mag_N is equal to the bit-length value indicated by the decoded bit-length information INF_{BD}′. If each of the encoded magnitude values Mag_0-Mag_N is generated by variable length coding (e.g., GR coding), the bit-length value indicated by the decoded bit-length information INF_{BD}′ is equal to a bit-length of a suffix part of each GR code.

The recovery circuit 404 shown in FIG. 4 receives the decoded magnitude data Mag(S)′ of the symbols S and the decoded sign data Sign(S)′ of at least a portion (i.e., part or all) of the symbols S, and generates decoded data of the symbols S according to the decoded magnitude data Mag (S)′ and the decoded sign data Sign(S)′. Specifically, when sign data removal is enabled at the entropy encoder 100 due to the fact that at least one zero symbol value is possessed by the symbols S of the pixel group, the decoded sign data Sign(S)′ do not include the sign value of the at least one zero symbol value; and when sign data removal is not enabled at the entropy encoder 100 due to the fact that all symbol values possessed by the symbols S of the pixel group have non-zero magnitude, the decoded sign data Sign(S)′ include the sign values of all non-zero symbol values possessed by the symbols S of the pixel group. Hence, when a decoded magnitude value of a symbol value is a zero magnitude value, the second bitstream portion BS2 contains no encoded sign value of the symbol value, and the decoded sign data Sign(S)′ do not include the sign value of the symbol value. The recovery circuit 404 enables the sign data recovery, such that a sign value of the symbol value is recovered at the recovery circuit 404 by directly using a pre-defined sign value (e.g., “+”).

It should be noted that parallel decoding of first bitstream portion BS1 and second bitstream portion BS2 as illustrated in FIG. 5 does not mean the whole sign data decoding procedure must be independent of the whole magnitude data decoding procedure. For example, when a magnitude value has a zero value, a corresponding encoded magnitude value would have a zero value. Hence, in some embodiments of the present invention, the entropy decoding circuit 402 may perform zero checking upon each encoded magnitude value (e.g., encoded Mag_0) included in the first bitstream portion BS1 to determine if the encoded magnitude value (e.g., encoded Mag_0) has a zero value, and may further refer to a zero checking result to determine if the second bitstream portion BS2 (which includes the encoded sign data) has an encoded sign value (e.g., encoded Sign_0) associated with the encoded magnitude value (e.g., encoded Mag_0). By way of example, but not limitation, zero checking results of all encoded magnitude values (e.g., encoded magnitude values Mag_0-Mag_N) included in the first bitstream portion BS1 may be used by the entropy decoding circuit 402 to decide the size of the second bitstream portion BS2. Though the first bitstream portion BS1 and the second bitstream portion BS2 may be decoded in a parallel manner, there may be certain dependency between decoding of the first bitstream portion BS1 and decoding of the second bitstream portion BS2.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An entropy encoding method comprising:
receiving symbols of a pixel group;
entropy encoding data derived from the symbols of the pixel group to generate a first bitstream portion and a second bitstream portion, wherein the first bitstream portion comprises encoded magnitude data of the symbols of the pixel group, and the second bitstream portion comprises encoded sign data of at least a portion of the symbols of the pixel group; and
generating a bitstream segment of the pixel group by combining at least the first bitstream portion and the second bitstream portion;
wherein the pixel group comprises a plurality of pixels, the symbols of the pixel group have a plurality of symbol values of the pixels, respectively, and when a first symbol value has a zero magnitude value, a sign value of the first symbol value is not entropy encoded into the second bitstream portion.

2. The entropy encoding method of claim 1, wherein entropy encoding the data derived from the symbols of the pixel group comprises:
entropy encoding magnitude values of the symbol values by fixed length coding.

3. The entropy encoding method of claim 2, wherein the fixed length coding encodes each of the magnitude values of the symbol values according to a bit-length value, where a bit-length of an encoded magnitude value of each of the symbol values is equal to the bit-length value.

4. The entropy encoding method of claim 3, wherein the fixed length coding sets the bit-length value by a maximum of minimum bit-lengths needed to fully represent the magnitude values of the symbol values in binary notation.

5. The entropy encoding method of claim 3, further comprising:
entropy encoding the bit-length value into the first bitstream portion.

6. The entropy encoding method of claim 1, wherein entropy encoding the data derived from the symbols of the pixel group comprises:
entropy encoding magnitude values of the symbol values by variable length coding.

7. The entropy encoding method of claim 6, wherein the variable length coding is Golomb-Rice (GR) coding.

8. The entropy encoding method of claim 7, wherein an encoded magnitude value of each of the symbol values comprises a prefix part and a suffix part, and the entropy encoding method further comprises:
entropy encoding a bit-length value of the suffix part into the first bitstream portion.

9. The entropy encoding method of claim 1, wherein the second bitstream portion is generated by run-length coding.

10. The entropy encoding method of claim 1, wherein combining at least the first bitstream portion and the second bitstream portion comprises:
concatenating the first bitstream portion and the second bitstream portion to form the bitstream segment of the pixel group, wherein an end of the first bitstream portion is followed by a start of the second bitstream portion.

11. The entropy encoding method of claim 1, wherein combining at least the first bitstream portion and the second bitstream portion comprises:
interleaving parts of the first bitstream portion and parts of the second bitstream portion to form the bitstream segment of the pixel group, wherein when a second symbol value has a non-zero magnitude value, an encoded magnitude value and an encoded sign value of the second symbol value are concatenated in the bitstream segment.

12. An entropy decoding method comprising:
receiving a bitstream segment composed of a first bitstream portion and a second bitstream portion;
entropy decoding the bitstream segment to derive decoded magnitude data of symbols of a pixel group from the first bitstream portion and derive decoded sign data of at least a portion of the symbols of the pixel group from the second bitstream portion, wherein the pixel group comprises a plurality of pixels, the symbols of the pixel group have a plurality of symbol values of the pixels, respectively; and
generating decoded data of the symbols of the pixel group according to the decoded magnitude data of the symbols and the decoded sign data of said at least a portion of the symbols, wherein when a decoded magnitude value of a first symbol value is a zero magnitude value, the decoded sign data contain no sign value of the first symbol value, and the sign value of the first symbol value is recovered by directly using a pre-defined sign value.

13. The entropy decoding method of claim 12, wherein entropy decoding the bitstream segment comprises:
entropy decoding encoded magnitude values of the symbol values by fixed length decoding.

14. The entropy decoding method of claim 13, wherein the fixed length decoding decodes each of the encoded magnitude values of the symbol values according to a bit-length value, where a bit-length of an encoded magnitude value of each of the symbol values is equal to the bit-length value.

15. The entropy decoding method of claim 14, wherein the fixed length decoding further derives the bit-length value from the first bitstream portion.

16. The entropy decoding method of claim 12, wherein entropy decoding the bitstream segment comprises:
entropy decoding encoded magnitude values of the symbol values by variable length decoding.

17. The entropy decoding method of claim 16, wherein the variable length decoding is Golomb-Rice (GR) decoding.

18. The entropy decoding method of claim 17, wherein an encoded magnitude value of each of the symbol values comprises a prefix part and a suffix part, and the GR decoding further derives a bit-length value of the suffix part from the first bitstream portion.

19. The entropy decoding method of claim 12, wherein the second bitstream portion is entropy decoded by run-length decoding.

20. The entropy decoding method of claim 12, wherein the first bitstream portion and the second bitstream portion are concatenated in the bitstream segment of the pixel group; an end of the first bitstream portion is followed by a start of the second bitstream portion; and entropy decoding the bitstream segment comprises:
entropy decoding the first bitstream portion and the second bitstream portion in a parallel manner.

21. The entropy decoding method of claim 12, wherein parts of the first bitstream portion and parts of the second bitstream portion are interleaved in the bitstream segment of the pixel group; and entropy decoding the bitstream segment comprises:
entropy decoding an encoded magnitude value and an encoded sign value of a second symbol value in a sequential manner, wherein a decoded magnitude value of the second symbol value has a non-zero magnitude value.

22. An entropy encoder comprising:
an entropy encoding circuit, arranged to receive symbols of a pixel group, and entropy encode data derived from the symbols of the pixel group to generate a first bitstream portion and a second bitstream portion, wherein the first bitstream portion comprises encoded magnitude data of the symbols of the pixel group, and the second bitstream portion comprises encoded sign data of at least a portion of the symbols of the pixel group; and
a combining circuit, arranged to generate a bitstream segment of the pixel group by combining at least the first bitstream portion and the second bitstream portion;
wherein the pixel group comprises a plurality of pixels, the symbols of the pixel group have a plurality of symbol values of the pixels, respectively, and when a first symbol value has a zero magnitude value, the entropy encoding circuit does not entropy encode a sign value of the first symbol value into the second bitstream portion.

23. An entropy decoder comprising:
an entropy decoding circuit, arranged to receive a bitstream segment composed of a first bitstream portion and a second bitstream portion, and entropy decode the bitstream segment to derive decoded magnitude data of symbols of a pixel group from the first bitstream portion and derive decoded sign data of at least a portion of the symbols of the pixel group from the second bitstream portion; and
a recovery circuit, arranged to generate decoded data of the symbols of the pixel group according to the decoded magnitude data of the symbols and the decoded sign data of said at least a portion of the symbols;
wherein the pixel group comprises a plurality of pixels, the symbols of the pixel group have a plurality of symbol values of the pixels, respectively, and when a decoded magnitude value of a first symbol value is a zero magnitude value, the decoded sign data contain no sign value of the first symbol value, and the recovery circuit recovers the sign value of the first symbol value by directly using a pre-defined sign value.
